(19) United States
(12) Patent Application Publication
(10) Pub. No.: US 2009/0213925 A1
(43) Pub. Date: Aug. 27, 2009

(54) BUFFER CONTROL DEVICE AND RECEIVING APPARATUS

(75) Inventors: Takeshi Inagaki, Kanagawa (JP); Kenji Tomizawa, Kanagawa (JP); Shinichi Oosawa, Tokyo (JP); Kouichi Kurihara, Saitama (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/388,749

(22) Filed: Feb. 19, 2009

(30) Foreign Application Priority Data
Feb. 22, 2008 (JP) 2008-041707

(51) Int. Cl. H04N 7/26; H04N 5/06

(52) U.S. Cl. 375/240.01; 348/521; 375/E07.026; 348/E05.011

(57) ABSTRACT

A buffer control device is provided with a nearly flow detecting section, a vertical cycle control section and a vertical synchronization signal generating section. The nearly flow detecting section compares the amount of data accumulated in a buffer and predetermined thresholds and detects the result of the comparison as nearly overflow or nearly underflow. The vertical cycle control section adjusts the length of a vertical synchronization cycle according to the result of the comparison by the nearly flow detecting section. The vertical synchronization signal generating section generates a new vertical synchronization signal from the result of the adjustment by the vertical cycle control section.

### CROSS REFERENCE TO RELATED APPLICATIONS

This application is based upon and claims the benefit of priority from the prior Japanese Patent Application No. 2008-041707 filed in Japan on Feb. 22, 2008; the entire contents of which are incorporated herein by reference.

### BACKGROUND OF THE INVENTION

1. Field of the Invention

The present invention relates to a buffer control device and a receiving apparatus for enabling a broadcast program to be reproduced.

2. Description of Related Art

In a digital broadcast receiving apparatus (hereinafter referred to as a receiving apparatus), a broadcast program can be generally reproduced by restoring 27 MHz on the basis of a PCR (Program Clock Reference) transmitted from a transmission side and decoding video and voice data on the basis thereof, as shown in the MPEG2 (Moving Picture Expert Group 2) standard adapted to a broadcast stream (Transport Stream; hereinafter referred to as a TS). The restored 27 MHz or the value of a counter which operates on the basis of the clock is called an STC (System Time Clock) or the like. There may be a case where the restored 27 MHz is expressed as an STC clock in order to clearly distinguish it from a counter value.

The TS is configured as an aggregate of 188-byte packets (hereinafter referred to as TS packets). Each packet of the TS is given an identifier PID (Packet Identifier) so that various packet data, such as video and voice, can be multiplex-transmitted.

The receiving apparatus is mounted with an STC counter which operates on the basis of the STC so as to finely adjust or control the frequency of 27 MHz on the basis of the difference between the value of the STC on the receiving side when a PCR is received from the transmission side and the value of the PCR at that time. Specifically, a rectangular wave signal (PWM control signal) of a duty ratio (a ratio of a high-level period to a low-level period of a signal) corresponding to the difference is generated. Then, it is smoothed, and its average voltage is provided for a VCXO (Voltage Controlled Xtal Oscillator) constituting a reference clock oscillator as a PWM control voltage, and the frequency of a reference clock is controlled so that the above-stated difference becomes 0. Such control is referred to as PWM (Pulse Width Modulation) control or the like.

For example, as for the value of the PCR and the value of the STC, if PCR>STC is satisfied, then the frequency of 27 MHz is increased a little. If PCR<STC is satisfied, then the frequency of 27 MHz is decreased a little.

When judgment about whether the frequency should be increased or decreased by PWM is made, it is converted to voltage for control and provided for the VCXO, and thereby, output of the VCXO becomes 27 MHz which has been restored (finely adjusted).

Since the PCR is a discrete counter value transmitted every several tens of milliseconds, the receiving apparatus continuously performs fine adjustment of 27 MHz by periodically repeating the PWM control. These techniques are also described in Japanese Patent Application Laid-Open Publication No. 2002-9747 and the like.

However, in a conventional receiving apparatus, it has been common to make adjustment in accordance with an original STC clock on the transmission side, by performing PWM control and the like using an expensive part such as a VCXO and the like to reproduce (restore) the 27 MHz reference clock on the basis of a PCR value transmitted from the transmission side together with a data stream.

On the other hand, if a reference clock oscillator is allowed to operate without performing PWM control and the like using a VCXO and the like (this is called free run), there is a problem that: buffer overflow or buffer underflow of a buffer, which is used for temporarily holding video or voice data when the video or voice data is decoded, may be caused and data loss may occur, so that a correct video or voice cannot be reproduced.

### BRIEF SUMMARY OF THE INVENTION

According to an aspect of the present invention, there is provided a buffer control device provided with: a nearly flow detecting section configured to compare the amount of data accumulated in a buffer and predetermined thresholds and detect the result of the comparison as nearly overflow or nearly underflow; a vertical cycle control section configured to adjust the length of a vertical synchronization cycle according to the result of the comparison by the nearly flow detecting section; and a vertical synchronization signal generating section configured to generate a new vertical synchronization signal on the basis of the result of the adjustment by the vertical cycle control section.

According to another aspect of the present invention, there is provided a receiving apparatus to which a broadcast program is transmitted as coded data in packets and which receives the data, the receiving apparatus provided with: the buffer control device described above; a system decoder configured to identify and output a packet having a predetermined identifier or a data pattern from inputted packets; a video decoder configured to decode video data among data outputted from the system decoder; a voice decoder configured to decode voice data among the data outputted from the system decoder; and a host processor configured to make at least settings for each of the decoders and the buffer control device required for receiving the broadcast program, among the data outputted from the system decoder.

### BRIEF DESCRIPTION OF THE DRAWINGS

FIG. 1 is a block diagram of a receiving apparatus to which a buffer control device of an embodiment of the present invention is applied;

FIG. 2 is an internal block diagram of a reproduction synchronization control section in FIG. 1;

FIGS. 3A and 3B are diagrams illustrating the operation of a ring buffer;

FIGS. 4A to 4C are diagrams illustrating an example of adjustment for nearly overflow;

FIGS. 5A to 5C are diagrams illustrating an example of adjustment for nearly underflow;

FIGS. 6A to 6C are diagrams illustrating a problem in the case where PWM control is not performed (an example of overflow) in a technique related to the present invention; and

FIGS. 7A to 7C are diagrams illustrating a problem in the case where PWM control is not performed (an example of underflow) in the technique related to the present invention.

### DETAILED DESCRIPTION OF THE INVENTION

An embodiment of the present invention will be described with reference to drawings.

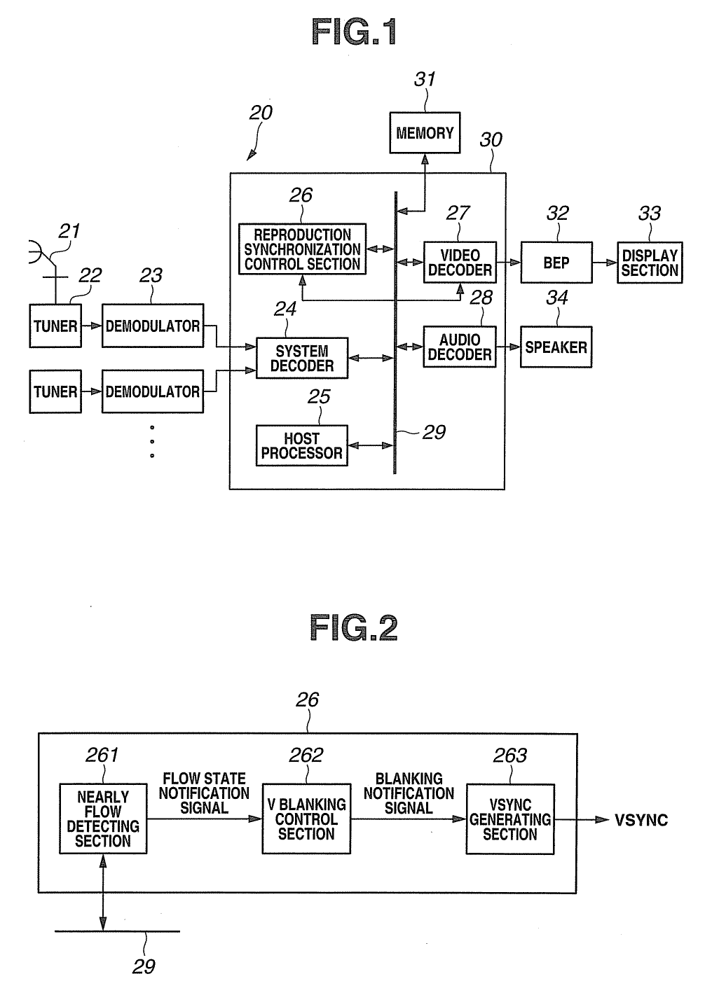

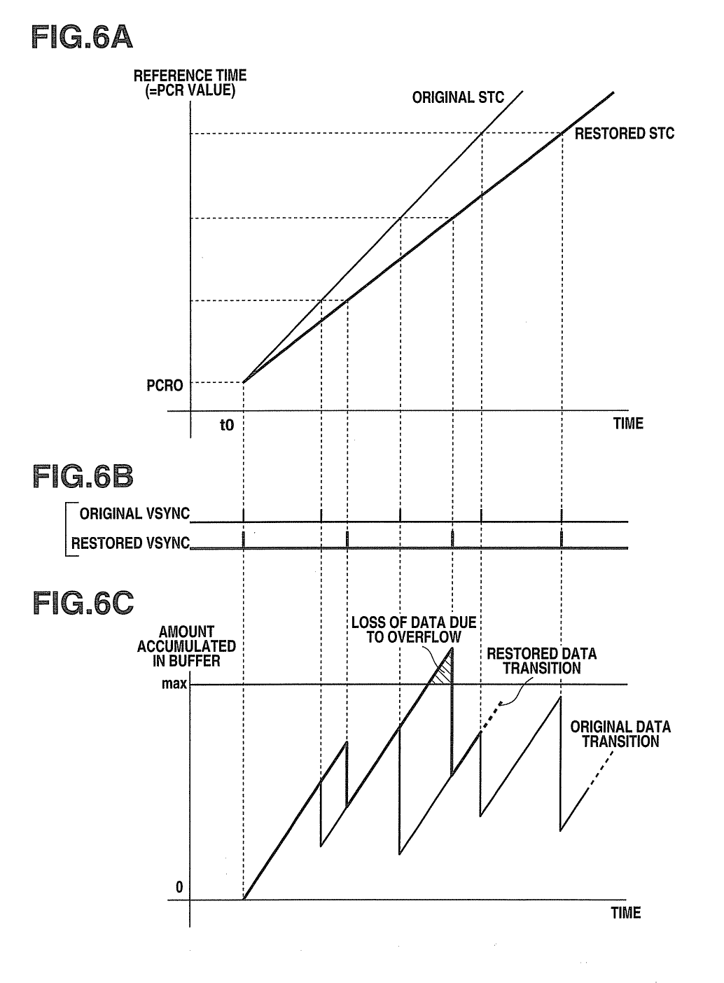

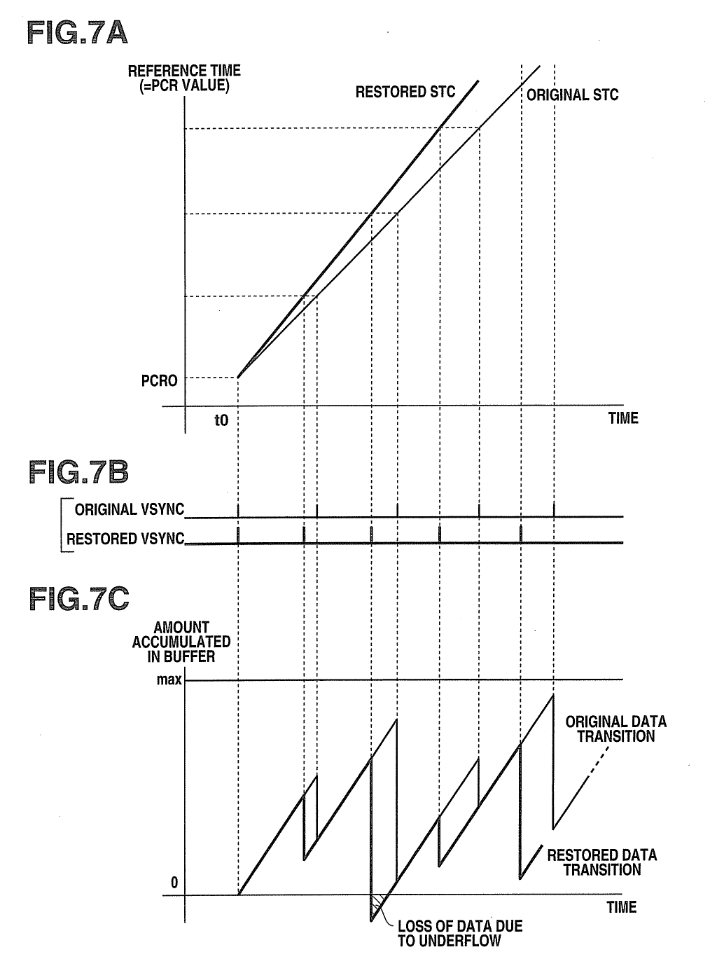

Before describing the embodiment of the present invention with reference to FIG. 1 to FIGS. 5A to 5C, a technique related to the present invention will be described with the use of FIGS. 6A to 6C and FIGS. 7A to 7C.

As described before, a receiving apparatus is mounted with an STC counter which operates on the basis of an STC, and it finely adjusts or controls the frequency of 27 MHz on the basis of the difference between the value of the STC on the receiving side at the time of receiving a PCR from the transmission side and the value of the PCR.

For example, PWM control is performed, for example, so as to increase the frequency of 27 MHz a little in the case of PCR>STC and decrease the frequency of 27 MHz a little in the case of PCR<STC.

When judgment about whether to increase or decrease the frequency by PWM control, it is converted to voltage for control and provided for a VCXO, and thereby, the output frequency of the VCXO becomes restored (finely adjusted) 27 MHz.

Since the PCR is a discrete counter value transmitted every several tens of milliseconds, the receiving apparatus continuously performs fine adjustment of 27 MHz by periodically repeating the PWM control.

Now, description will be made below on what problem is caused when fine adjustment of 27 MHz is not performed.

FIGS. 6A to 6C and FIGS. 7A to 7C are diagrams illustrating a problem caused when fine adjustment of 27 MHz is not performed (this is called “allowing free run”) after the STC counter is initialized with a PCR received from the transmission side first, in the receiving apparatus. FIGS. 6A to 6C show that 27 MHz allowed to free run is lower than 27 MHz which counts the PCR from the transmission side, and FIGS. 7A to 7C show that the 27 MHz allowed to free run is higher.

FIGS. 6A to 6C will be described first.

When a PCR0 is received at time t0, and after that, an STC is restored while 27 MHz is allowed to free run (without PWM control), the restored STC is counted later than a PCR corresponding to an original STC. This is shown in FIG. 6A. The horizontal axis indicates a time axis, and the vertical axis indicates a time axis based on the value of the original PCR from the transmission side. Since the time interval (scale) of the horizontal axis and the time interval (scale) of the vertical axis are shown to be equal, the “original STC” shows the slope of 45°.

The “restored STC” in FIG. 6A should be restored with the same slope as that of the original PCR like the “original STC”. However, if 27 MHz later than the original PCR is allowed to free run, the slope is smaller than the “original STC” like the shown “restored STC”.

In the receiving apparatus, decoding or restoration of a vertical synchronization signal (VSYNC) to be a display timing are performed on the basis of the STC clock. The vertical frequency of the VSYNC is generally 60 Hz or 50 Hz. When converted to the number of counts at 27 MHz, it is 450,000 or 540,000. This is shown in FIG. 6B.

Though a “restored VSYNC” restored as shown in FIG. 6B should be restored like an “original VSYNC”. However, if 27 MHz later than the original PCR is allowed to free run, the “restored VSYNC” is restored in a state that the cycle is lengthened like the shown “restored VSYNC” in comparison with the original cycle.

An ideal decoding operation of MPEG2 needs to be performed by using (decoding or reproducing) data accumulated in an STD (System Target Decoder) buffer for a certain VSYNC period, at a subsequent VSYNC timing, without causing overflow or underflow of the buffer for decoding, in other words, loss of data. The STD buffer for video data may be referred to as a VBV (Video Buffering Verifier) buffer. The state is shown in FIG. 6C. FIG. 6C shows that data is gradually written in the buffer during a VSYNC period and, after an elapse of the VSYNC period, read in an instant.

If 27 MHz later than the original PCR is allowed to free run when the data in the buffer should transition as shown by “original data transition” (indicated by a thin solid line) in FIG. 6C, it induces buffer overflow, a state in which the amount of data exceeds the remaining capacity of the buffer, as indicated by “restored data transition” (indicated by a thick solid line) in FIG. 6C. That is, when the amount of data written in the buffer exceeds the maximum value (max) of the amount accumulated in the buffer, loss of data due to overflow occurs, and it is not possible to reproduce correct video and voice.

Next, FIGS. 7A to 7C will be described.

The difference from FIGS. 6A to 6C is that FIGS. 7A to 7C show an example in which a “restored STC” which is restored is counted at 27 MHz faster than a PCR corresponding to the original STC. When 27 MHz faster than the original PCR is allowed to free run, the slope of the “restored STC” is larger than the slope of the “original STC” (shown with a slope of 45°), as in FIG. 7A.

Therefore, the cycle of the “restored VSYNC” is restored in a state of being shortened in comparison with the “original VSYNC”, as in FIG. 7B.

As a result, buffer underflow, a state in which there is not data in the buffer (a state in which reading beyond 0, the minimum value of the accumulated amount of data, is performed), is induced as indicated by “restored data transition” (indicated by a thick solid line) in FIG. 7C. That is, since the cycle of the restored VSYNC is short, reading is performed in a state that there is a small amount of data written in the buffer. Therefore, loss of data due to underflow occurs, and it is not possible to reproduce correct video and voice.

Accordingly, the embodiment of the present invention proposes a buffer control device which enables reproduction without loss of data by devising control of data transition in an STD (System Target Decoder) buffer in the case where an expensive part such as a VCXO is not used, in other words, in the case where PWM control and the like by a VCXO are not performed; and a receiving apparatus using the buffer control device.

FIG. 1 is a block diagram of a receiving apparatus to which a buffer control device of an embodiment of the present invention is applied.

A receiving apparatus 20 shown in FIG. 1 is provided with an antenna 21, a tuner 22, a demodulator 23, a system decoder 24, a host processor 25, a reproduction synchronization control section 26 as a buffer control device, a video decoder 27, an audio decoder 28, a data path 29, a memory 31, a back end processor (hereinafter referred to as a BEP) 32, a display section 33 and a speaker 34.

An MPEG decoder 30 is constituted by the system decoder 24, the host processor 25, the video decoder 27, the audio decoder 28 and the data path 29.

As shown in FIG. 1, stream data at a wireless frequency is inputted into the tuner 22 via the antenna 21. The tuner 22 converts the inputted wireless frequency signal to a baseband signal and outputs it to the demodulator 23. The demodulator 23 performs demodulation processing of the inputted baseband signal to restore a TS and outputs it to the system decoder 24. The demodulation processing by the demodulator 23 includes, for example, at least any of conversion from an analog signal to a digital signal, demultiplex demodulation if a received signal is multiplex-modulated, error correction processing and the like. In the case of a receiving apparatus mounted with two tuners (called a double tuner) or more tuners, it is assumed that the antenna 21 or a different antenna (not shown) is similarly connected to the tuners.

In the case of a double tuner and the like, the same number of demodulators 23 as the number of tuners are required. However, a demodulator called a multi-demodulator exists, which can respond to two or more baseband signals. In FIG. 1, one demodulator is provided for each of multiple tuners, as a logically necessary number.

The system decoder 24 selects a TS packet which satisfies a filter condition set by the host processor 25 in advance, for example, which has a set PID, extracts necessary data (information) from the TS packet, and outputs (or writes) it to a buffer in the memory 31 set by the host processor 25 in advance via the data path 29. The buffer is set as a buffer area in the memory 31. Video data and voice data are classified by the system decoder 24.

The video data and the voice data are outputted to an STD buffer for video in the memory 31 and an STD buffer for audios in the memory 31, respectively. In this way, the video and voice data classified by the system decoder 24 are provided for the video decoder 27 and the audio decoder 28 via the dedicated buffers provided in the memory 31, respectively.

The video decoder 27 decodes the video data provided (or read) from the memory 31 in accordance with a vertical synchronization signal (hereinafter referred to as a VSYNC) provided by the reproduction synchronization control section 26, and outputs video information obtained as a result to the BEP 32. The BEP 32 performs various image processings, such as color correction, for the video information and displays it on the display section 33. The display section 33 is any of various display devices such as an LCD (Liquid Crystal Display), a PDP (Plasma Display Panel) and a CRT (Cathode Ray Tube).

The audio decoder 28 decodes audio data provided (or read) from the memory 31 and outputs voice information obtained as a result to the speaker 34 as voice. An audio decoding timing generation method is not limited in the present invention. For example, it is possible to make adjustment to a synchronization signal VSYNC like the video decoder 27 and it is also possible to receive time information (PTS: Presentation Time Stamp) about video data of a video which is currently being decoded or which is going to be displayed and perform decoding in accordance with the time information PTS. The present embodiment can be adapted to any of the cases, and the method is not limited.

When video auxiliary data such as character data is transmitted, the system decoder 24 can also classify the data as private data and provide it for the host processor 25 via the memory 31. The host processor 25 can decode the data as character information or the like and output it in a state of being overlapped on video information via the video decoder 27.

FIG. 2 shows an internal block diagram of the reproduction synchronization control section 26.

The reproduction synchronization control section 26 shown in FIG. 2 is provided with a nearly flow detecting section 261, a V blanking control section 262 as a vertical cycle control section, a VSYNC generating section 263 as a vertical synchronization signal generating section, and a free-running single-frequency crystal oscillator (Xtal), not shown, requiring no voltage control. The frequency of the crystal oscillator used here may be any frequency that can generate a clock required for display and is not limited to 27 MHz for an STC. It is sufficient if there is a required clock, and the clock may be inputted from the outside, though a crystal oscillator is used here. However, if the frequency is not 27 MHz, 27 MHz for the STC is separately required.

The nearly flow detecting section 261 compares the amount of data accumulated in the buffer and certain thresholds set in advance, and detects the result of the comparison as nearly overflow or nearly underflow. Assuming the thresholds to be the amount of data from a buffer start pointer, the nearly flow detecting section 261 detects the case where the accumulated amount of data is equal to or larger than a first threshold or larger than the first threshold as nearly overflow, and detects the case where the accumulated amount of data is equal to or smaller than a second threshold or smaller than the second threshold as nearly underflow. The detected state of nearly overflow or nearly underflow is outputted from the nearly flow detecting section 261 as a flow state notification signal. The first threshold and the second threshold may be the same.

A clock from the crystal oscillator (Xtal) not shown is inputted to the V blanking control section 262, and the V blanking control section 262 adjusts the length of the vertical synchronization cycle on the basis of the result of the comparison by the nearly flow detecting section 261. The V blanking control section 262 adjusts, for example, only a blanking period in the vertical synchronization cycle. Therefore, a blanking notification signal which notifies an adjusted blanking period is outputted from the V blanking control section 262.

The VSYNC generating section 263 generates a new vertical synchronization signal (VSYNC) on the basis of the result of the adjustment by the V blanking control section 262 and outputs it.

The thresholds are given to the nearly flow detecting section 261 in advance by the host processor 25 via the data path 29 or a path not shown. By periodically comparing these thresholds with the amount of data accumulated in the buffer (hereinafter referred to as the amount accumulated in the buffer) or the remaining capacity for data of the buffer (hereinafter referred to as the remaining capacity of the buffer), the nearly flow detecting section 261 detects a nearly overflow state (a state of overflow being going to occur) or a nearly underflow state (a state of underflow being going to occur) depending on whether the amount is upper or lower (larger or smaller) than the thresholds and notifies it to the V blanking control section 262. A threshold used for detecting nearly overflow and a threshold used for detecting nearly underflow are called a nearly overflow threshold and a nearly underflow threshold, respectively.

As the timing of the comparison with the thresholds is, for example, the time of the system decoder 24 writing data into the buffer is appropriate in the case of nearly overflow, and the time of the video decoder 27 and the audio decoder 28 reading data from the buffer is appropriate in the case of underflow. However, the present embodiment is not necessarily limited to any comparison timing.

The thresholds can be determined at appropriate positions between the maximum value (max) and minimum value (0) of the amount accumulated in the buffer. The nearly overflow threshold as the first threshold can be determined at a position of an appropriate value which is between the maximum value (max) and minimum value (0) of the amount accumulated in the buffer and near and smaller than the maximum value (max). The nearly overflow threshold as the second threshold can be determined at a position of an appropriate value which is near and larger than the minimum value (0). Though the nearly overflow threshold and the nearly underflow threshold are generally different values, the same one threshold can be used as both of the nearly overflow threshold and the nearly underflow threshold.

The comparison of the thresholds and the accumulated amount of data can be performed by receiving a write pointer WP indicating how much of the buffer has been used to write data, from the system decoder 24 via the data path 29 or a path not shown and receiving a read pointer RP indicating from how much of the buffer data has been read, from the video decoder 27. Here, the buffer is used as a ring buffer.

When a start pointer and an end pointer of a buffer area set by the host processor 25 are assumed to be SP and EP, the accumulated amount of data can be calculated as shown below. Since it can be arbitrarily determined where on the memory 31 SP and EP should be set, it is possible to set a buffer area formed between SP and EP, for example, as an area of addresses 4F8 to ABC on the memory.

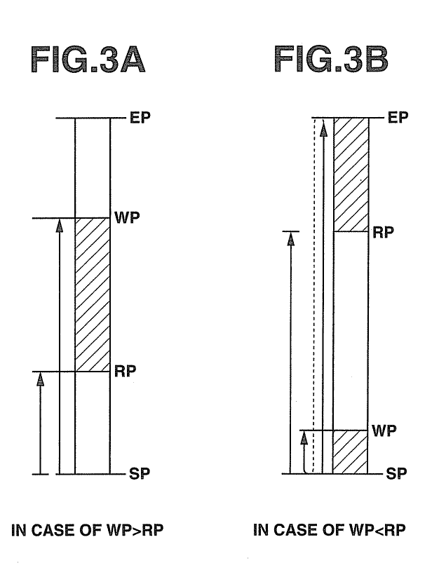

FIGS. 3A and 3B show the operation of a ring buffer. Between SP and EP, shaded parts indicate the accumulated amount of data, and white parts indicate an empty part where data is not written (the remaining capacity of the buffer).

FIG. 3A shows the case of WP>RP, and FIG. 3B shows the case of WP<RP.

FIG. 3A shows a state that, after data is written, from SP to WP in the buffer area between SP and EP, data from SP to RP is read (the state of WP>RP). FIG. 3B shows a state that, data is written up to EP in the state of FIG. 3A, and, after returning to SP (shown by a dotted line) and writing data from SP to WP, data up to the position of RP is read (the state of WP<RP).

If WP>RP, then the accumulated amount of data=WP−RP.

If WP<RP, then the accumulated amount of data=(EP−RP)+(WP−SP).

By assuming the thresholds to be the amount of data from SP, nearly overflow in the case of the accumulated amount of data>nearly overflow threshold, and nearly underflow can be notified in the case of the accumulated amount of data<nearly underflow threshold can be notified to the next V blanking control section 262.

It is also possible to notify nearly overflow if the accumulated amount of data is equal to or above the nearly overflow threshold and notify nearly underflow if the accumulated amount of data is equal to or below the nearly underflow threshold.

In the case of comparison with the remaining capacity of the buffer, calculation can be performed as below by receiving WP and RP similarly to the above case.

If WP>RP, then the remaining capacity of the buffer=(EP−WP)+(RP−SP).

If WP<RP, then the remaining capacity of the buffer=RP−WP.

By assuming the thresholds to be the amount of data from EP, nearly overflow in the case of the remaining capacity of the buffer<nearly overflow threshold, and nearly underflow in the case of the remaining capacity of the buffer>nearly underflow threshold can be notified to the next V blanking control section 262.

It is also possible to notify nearly overflow if the remaining capacity of the buffer is equal to or below the nearly overflow threshold and notify nearly underflow if the remaining capacity of the buffer is equal to or above the nearly underflow threshold.

Though it is possible receive each of SP, EP, WP and RP from the updating blocks (the host processor 25, the system decoder 24 and the video decoder 27) as described above, it is desirable to refer to these pointers from the system decoder 24, the video decoder 27 and the audio decoder 28 in common. For example, a mechanism (a storage element such as a memory and a register) for holding the values of these pointers may be provided for the memory 31, the reproduction synchronization control section 26 or a block not shown.

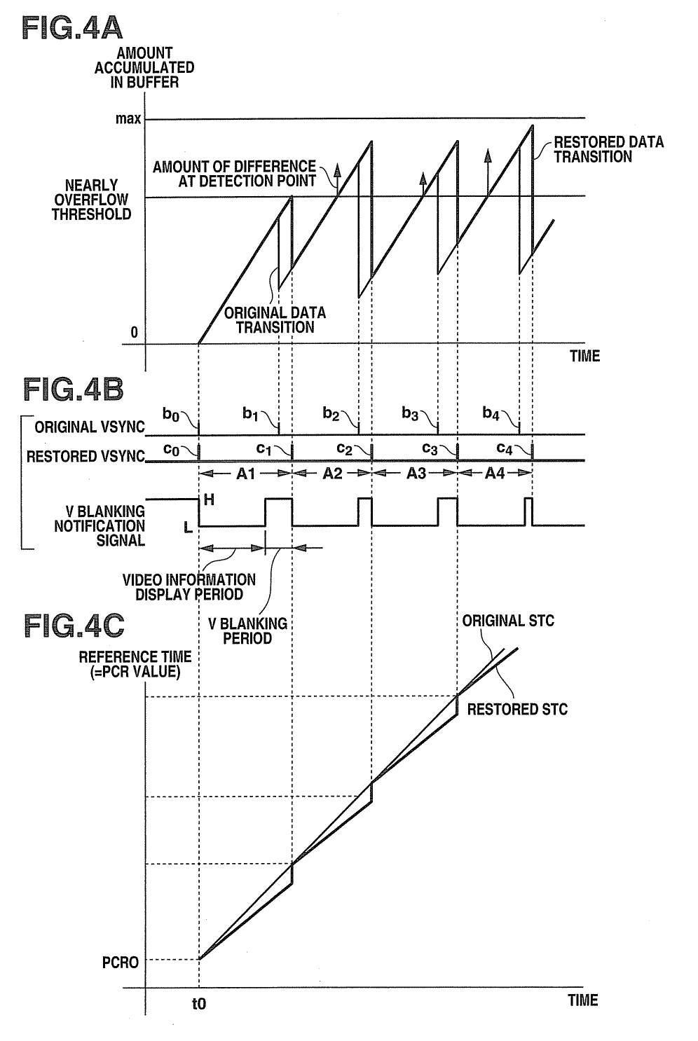

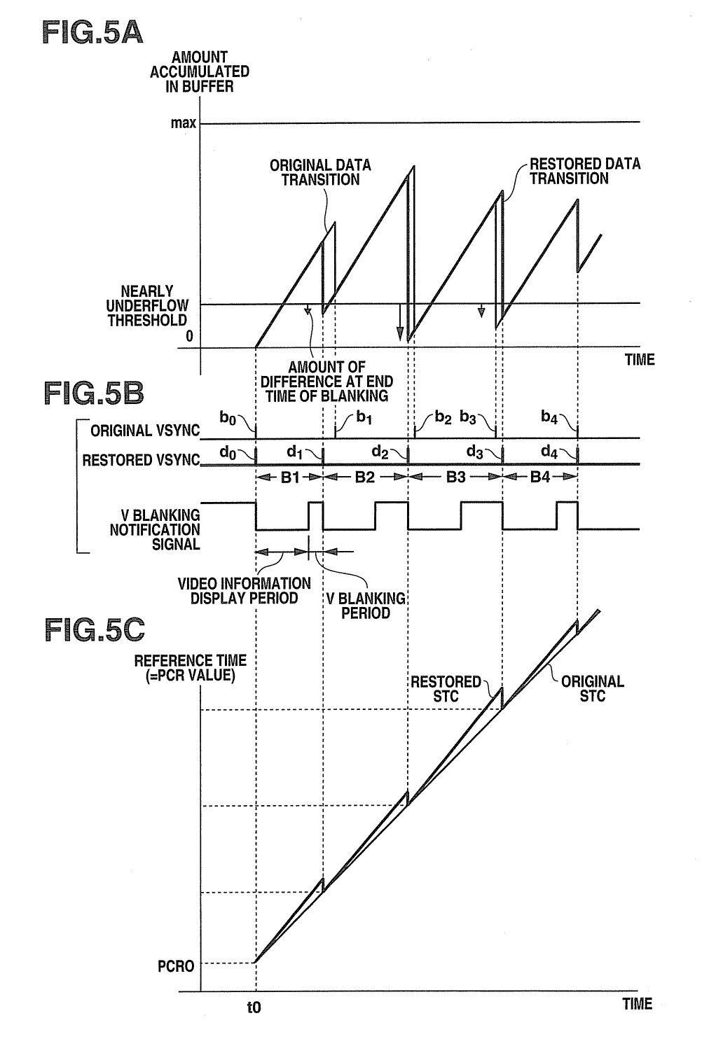

Description will be made below on the case of using the accumulated amount of data for comparison with the threshold as an example, with reference to FIGS. 4A to 4C and FIGS. 5A to 5C for the purpose of simplifying the description and facilitating understanding of the description.

The V blanking control section 262 detects a period before and after the VSYNC during which it is not necessary to display video information, as a V blanking period (time), and shortens or lengthens the V blanking period in accordance with a signal notified from the nearly flow detecting section 261.

FIGS. 4A to 4C show adjustment performed for nearly overflow, and FIGS. 5A to 5C show adjustment performed for nearly underflow.

First, an example of adjustment for preventing overflow in FIGS. 4A to 4C will be described.

When nearly overflow is notified from the nearly flow detecting section 261, the accumulated amount of data in the STD buffer is above the nearly overflow threshold as shown in FIG. 4A.

When nearly overflow is notified like this, the V blanking control section 262 adjusts (compresses or expands) the length of the V blanking period.

For example, when a video with the vertical frequency (the number of fields) of 60 Hz is considered as an example, a video corresponding to one cycle (one field) is generally configured by horizontal 262.5 lines. Among these lines, 240 lines correspond to a video information display period, and 22.5 lines correspond to the V blanking period.

The length (the number of lines or the number of cycles at 27 MHz) and direction thereof to be adjusted (to be shortened or lengthened) are determined on the basis of at least any one of time until V blanking is started after nearly overflow is notified, the number of notifications, the number of notifications in the past, the number of lines or the number at the time of notification, the accumulated amount of data or the remaining capacity of the buffer (including the amount of difference from thresholds) at the time of notification, the accumulated amount of data or the remaining capacity of the buffer (including the amount of difference from thresholds) at the start time of V blanking, and the data accumulation or consumption speed (the rate of data input or output).

In FIGS. 4A and 4B, an “original VSYNC” indicates a period for each constant vertical cycle (for each field), and the value of restored data transition (the accumulated amount of data in the buffer indicated by a thick line) is detected at detection points (b1, b2, b3, b4, . . . shown in the figures) for the constant periods of the original VSYNC. The “original VSYNC” means a VSYNC generated from 27 MHz clock synchronized with a PCR.

In FIG. 4A, as data to be decoded is written into the buffer, the accumulated amount of data in the buffer gradually and linearly increases. At the time of a restored VSYNC (c1) determined on the basis of the accumulated amount of data detected at the detection point b1 and the nearly overflow threshold, data is read from the buffer in an instant. As a result, the amount accumulated in the buffer decreases instantaneously. After that, data is written into the buffer again, and the amount accumulated in the buffer gradually and linearly increases. At the time of a restored VSYNC (c2) determined on the basis of the accumulated amount of data detected at the detection point b2 and the nearly overflow threshold, data is read from the buffer in an instant. Such an operation is repeated. Here, though the time among the points of the original VSYNC (b0, b1, b2, b3, . . . ) is the same, the time (A1, A2, A3, . . . ) among the points of the restored VSYNC (c0, c1, c2, c3, . . . ), that is, the lengths of the vertical synchronization cycles are automatically adjusted and, therefore, are not the same.

In other words, in the example of adjustment for suppressing nearly overflow in FIGS. 4A to 4C, a restored data value corresponding to the peak of a saw-toothed waveform of the original data transition of the amount accumulated in the buffer (the waveform indicated by a thin line in the case of assuming change in the cycle of the original VSYNC) is detected. In the process of increase in the accumulated amount of data during the first restored data transition period (a first period A1 of the restored VSYNC (c0 to c1)) shown in the figures, the nearly overflow threshold is not exceeded at the first detection point b1 based on the original VSYNC. Therefore, until the nearly overflow threshold is reached, a V blanking state starting after a video information display period (a period corresponding to a predetermined number of lines, for example, 240 lines) elapses is maintained. The V blanking state is controlled so that, when it is detected that the amount accumulated in the buffer reaches the nearly overflow threshold, it is notified to the V blanking control section 262, and, as a result, the V blanking control section 262 ends the V blanking state.

In response to nearly overflow being notified once, a V blanking period in the VSYNC period is adjusted according to the amount of difference between the amount accumulated in the buffer at the time of starting V blanking at the next detection point b2 based on the original VSYNC and the nearly overflow threshold (indicated by ↑ above the line of the nearly overflow threshold in FIG. 4A). If the amount of difference (=the amount accumulated in the buffer−the nearly overflow threshold) is large, adjustment is made so that the V blanking period is shortened. If the amount of difference is small, adjustment is made so that the V blanking period is lengthened. That is, if the amount accumulated in the buffer is above the nearly overflow threshold, control is performed to shorten time for accumulation of data into the buffer (for example, a V blanking period in the vertical cycle period) so that the accumulated amount of data in the vertical cycle period is decreased according to the magnitude of the amount of difference relative to the threshold.

The adjusted blanking period can be known from the length of a high level period of a V blanking notification signal (see FIG. 4B) outputted from the V blanking control section 262.

In the example of FIGS. 4A to 4C, the V blanking notification signal is assumed to be such a signal that the video information display period (a period during which it is necessary to display video information) is denoted by “L” and the V blanking period (a period during which it is unnecessary to display video information) is denoted by “H”.

The present embodiment does not limit the format of the V blanking notification signal to that described above. For example, it is possible to use such a signal that the video information display period is denoted by “H”, and the V blanking period is denoted by “L”, such a signal that “L” and “H” are toggled at the timing of start of the video information display period, a signal of two or more bits, a signal simply meaning that the blanking period is to be lengthened or shortened, and a signal indicating the length of the blanking period by a numerical value. Any of these signal may be used in the present embodiment.

Furthermore, in the present embodiment, the adjustment period is limited to the V blanking period during which video information is not displayed as described above. This is intended to suppress adverse effects (video shift, color shift and the like for each line) given to video information displayed on the display section 33.

Furthermore, though it is shown that adjustment (shortening or lengthening) of V blanking with a length corresponding to several tens of lines is performed per VSYNC in order to facilitate understanding, the accuracy of 27 MHz as a reference clock is specified as ±81 Hz in the MPEG2 standard. Even if a small error is actually included, it can be estimated to be about ±100 Hz at the most. That is, if 27 MHz is allowed to free run, a restored STC is counted with a difference of 200 Hz at the maximum from an original STC. And, it is a slope difference corresponding to only three to four counts per VSYNC (60 Hz or 50 Hz). Therefore, adjustment of V blanking is estimated to be a length corresponding to one line at the most every several VSYNCs.

As a result of the control in FIG. 4B, the video decoder 27 or the display section 33 practically measures the timing of starting decoding or display by referring to the “restored STC” shown in FIG. 4C. In the present embodiment, the start timing is the timing of consuming data in the buffer. Since, at this timing (at the time of data transition changing in the vertical direction), the “restored STC” transits along almost the same values of the “original STC”, video reproduction equivalent to that by referring to the “original STC” can be performed.

Next, an example of adjustment for suppressing underflow in FIGS. 5A to 5C will be described.

When nearly underflow is notified from the nearly flow detecting section 261, the accumulated amount of data in the STD buffer is below the nearly underflow threshold as shown in FIG. 5A.

When nearly underflow is notified, the V blanking control section 262 also adjusts the length of the V blanking period.

The length (the number of lines or the number of cycles at 27 MHz) and direction thereof to be adjusted (to be shortened or lengthened) are determined on the basis of at least any one of time until nearly overflow is notified after V blanking is started, the number of notifications, the number of notifications in the past, the number of lines or the number at the time of notification, the accumulated amount of data or the remaining capacity of the buffer (including the amount of difference from thresholds) at the time of notification, the accumulated amount of data or the remaining capacity of the buffer (including the amount of difference from thresholds) at the end time of V blanking, and the data accumulation or consumption speed (the rate of data input or output).

In FIGS. 5A and 5B, an “original VSYNC” indicates a period for each constant vertical cycle (field), and a “restored VSYNC” corresponds to the timing at the end of blanking (the time of reading from the buffer) in restored data transition indicated by a thick line. In the example of FIGS. 5A to 5C, the restored VSYNC (denoted by reference symbols d0, d1, d2, d3, . . . ) is the same as the displayed VSYNC, and the value of the amount accumulated in the buffer is detected at this timing. Here, the original VSYNC (denoted by reference symbols b0, b1, b2, b3, . . . ) is shown simply for reference. Though the time among the points of the original VSYNC (b0, b1, b2, b3, . . . ) is the same, the time (B1, B2, B3, . . . ) among the points of the restored VSYNC (d0, d1, d2, d3, . . . ), that is, the length of the vertical synchronization cycle is automatically adjusted and, therefore, is not the same.

In other words, in the example of adjustment for preventing underflow in FIGS. 5A to 5C, the original VSYNC (d0, d1, d2, d3, . . . ), that is, the end of blanking is equivalent to the timing of display. In the process of increase in the accumulated amount of data during the first restored data transition period (a first period B1 of the restored VSYNC (d0 to d1)) shown in the figures, the amount accumulated in the buffer gradually and linearly increases as data to be decoded is written into the buffer. At an appropriate timing (which may be determined in advance) when a predetermined video information display period has elapsed, the data accumulated in the buffer is read in an instant. As a result, the amount accumulated in the buffer decreases instantaneously. Depending on how much the amount accumulated in the buffer has decreased, that is, if it has decreased to be below the nearly underflow threshold though it cannot be below the threshold because the minimum amount of data to be held is usually specified, then it is detected and notified to the V blanking control section 262. The length of a V blanking period in a next vertical cycle (field) period is adjusted according to the amount corresponding to the difference from the threshold (the amount of difference).

In response to nearly underflow being notified once, the V blanking period in a next restored VSYNC period is adjusted according to the amount of difference between the accumulated amount of data at the end time of V blanking and the nearly under threshold (indicated by ↓ below the line of the nearly under threshold in FIG. 5A). For example, the length of a V blanking period in the next restored VSYNC period B2 is determined according to the amount of difference between the value of restored data transition (the amount accumulated in the buffer) detected at the reading timing d1 and the nearly underflow threshold. As a result, the amount accumulated in the buffer decreases instantaneously. After that, data is written into the buffer again, and the amount accumulated in the buffer gradually and linearly increases. Detection is performed again at the reading timing d2 on the basis of the length of the V blanking period determined before, and the length of a V blanking period in the next restored VSYNC period B3 is determined according to the amount of difference between the detected value of the restored data transition (the amount accumulated in the buffer) and the nearly underflow. Such an operation is repeated. If the amount of difference (=the nearly underflow threshold−the accumulated amount of data) is large, adjustment is made so that the V blanking period is lengthened. If the amount of difference is small, adjustment is made so that the V blanking period is shortened. That is, if the amount accumulated in the buffer is below the nearly underflow threshold, control is performed to lengthen time for accumulation of data into the buffer (for example, a V blanking period in the vertical cycle period) so that the accumulated amount of data in a next vertical cycle period is increased according to the magnitude of the amount of difference relative to the threshold.

Similarly to FIGS. 4A to 4C, the adjusted blanking period can be known from the length of a high level period of a V blanking notification signal (see FIG. 5B) outputted from the V blanking control section 262.

As a result of the control in FIG. 5B, the video decoder 27 or the display section 33 practically measures the timing of starting decoding or display by referring to the “restored STC” shown in FIG. 5C. In the present embodiment, the start timing is the timing of consuming data in the buffer. Since, at this timing (at the time of data transition changing in the vertical direction), the “restored STC” transitions along almost the same values of the “original STC”, video reproduction equivalent to that by referring to the “original STC” can be performed similarly to FIGS. 4A to 4C.

In the examples in FIGS. 4A to 4C and FIGS. 5A to 5C described above, description has been made on adjustment (shortening or lengthening) of the V blanking period in a VSYNC period for which nearly overflow or nearly underflow is notified or the V blanking period in a next VSYNC period as an example. However, the present invention is not limited thereto. For example, it is possible to adjust a VSYNC period two or more VSYNC periods before a notified VSYNC period, or it is also possible to not only adjust the V blanking of a notified VSYNC period but also continuously or periodically adjust a certain number of VSYNC periods. The present embodiment includes all of these.

By detecting a point of change in a V blanking notification signal, the VSYNC generating section 263 generates a VSYNC. This is shown as the “restored VSYNC” together with a V blanking notification signal in FIGS. 4B and 5B. In the present embodiment, it is possible to generate a VSYNC by detecting, as a point of change in a V blanking notification signal, a fall of the V blanking notification signal.

It is also possible to cause a fixed time difference (delay time) to exist between the VSYNC and the point of change in a V blanking notification signal, and this is also included in the present invention. For example, it is possible to generate (make active) a VSYNC with a 100-cycle delay from a fall of a V blanking notification signal at 27 MHz.

Furthermore, the polarity of the VSYNC may be not “H” active but “L” active. The active time may correspond not to 27 MHz or one cycle of a horizontal line but to a period corresponding to two or more cycles. The present embodiment includes all of these.

Though an STC generated on the receiving side on the basis of a PCR included in packet data and sent from a broadcasting station is required by the video decoder 27 and the audio decoder 28 in the receiving apparatus in FIG. 1, it is not required by the reproduction synchronization control section 26.

According to the embodiment of the present invention, the accumulated amount of data in a buffer and predetermined thresholds are compared; the length of a vertical synchronization cycle is adjusted on the basis of the result of the comparison; and a new vertical synchronization signal is generated on the basis of the result of the adjustment. Therefore, the length of the vertical synchronization cycle is automatically adjusted so as to prevent overflow or underflow in the buffer. Consequently, it is possible to reproduce video or voice without using an expensive part such as a VCXO, without performing PWM control or the like, and without loss of data.

As described above, according to the present embodiment, it is possible to reproduce video without loss of data by suppressing overflow and underflow of an STD buffer without PWM control.

Since PWM control is not required, a receiving apparatus can be configured not by an expensive part such as a VCXO but by an inexpensive single-frequency crystal oscillator (Xtal) which does not require voltage control.

Having described the embodiment of the invention referring to the accompanying drawings, it should be understood that the present invention is not limited to the precise embodiment and various changes and modifications thereof could be made by one skilled in the art without departing from the spirit or scope of the invention as defined in the appended claims.

What is claimed is:

1. A buffer control device comprising:
a nearly flow detecting section configured to compare the amount of data accumulated in a buffer and predetermined thresholds and detect the result of the comparison as nearly overflow or nearly underflow;
a vertical cycle control section configured to adjust the length of a vertical synchronization cycle according to the result of the comparison by the nearly flow detecting section; and
a vertical synchronization signal generating section configured to generate a new vertical synchronization signal on the basis of the result of the adjustment by the vertical cycle control section.

2. The buffer control device according to claim 1, wherein a threshold used for the detection of the nearly overflow is set to an appropriate value smaller than the maximum value of the accumulated amount of data, and a threshold used for the detection of the nearly underflow is set to an appropriate value larger than the minimum value of the accumulated amount of data.

3. The buffer control device according to claim 1, wherein the nearly flow detecting section assumes the thresholds to be the amount of data from a buffer start pointer, detects a case where the accumulated amount of data is equal to or larger than, or larger than a first threshold, as nearly overflow, and detects a case where the accumulated amount of data is equal to or smaller than, or smaller than a second threshold, as nearly underflow.

4. The buffer control device according to claim 1, wherein the buffer is used as a ring buffer.

5. The buffer control device according to claim 1, wherein a clock from a crystal oscillator is inputted to the vertical cycle control section, and the vertical cycle control section adjusts the length of the vertical synchronization cycle according to the result of the comparison by the nearly flow detecting section.

6. The buffer control device according to claim 1, wherein the vertical cycle control section adjusts only a blanking period in the vertical synchronization cycle.

7. The buffer control device according to claim 6, wherein the adjustment of the blanking period by the vertical cycle control section is performed by adjusting a blanking period in a vertical synchronization period where nearly overflow has been detected by the nearly flow detecting section in the case of suppressing nearly overflow, and is performed by adjusting a blanking period in a vertical synchronization period following a vertical synchronization period where nearly underflow has been detected by the nearly flow detecting section in the case of preventing nearly underflow.

8. The buffer control device according to claim 6, wherein
when the nearly flow detecting section detects that the accumulated amount of data is equal to or larger than, or larger than a first threshold for detecting nearly overflow, the vertical cycle control section adjusts a blanking period in the vertical synchronization period, depending on whether the amount of difference between the accumulated amount of data and the first threshold is large or small, shortens the blanking period if the amount of difference is large, and lengthens the blanking period if the amount of difference is small; and
when the nearly flow detecting section detects that the accumulated amount of data is equal to or smaller than, or smaller than a second threshold for detecting nearly underflow, the vertical cycle control section adjusts the blanking period in the vertical synchronization period, depending on whether the amount of difference between the second threshold and the accumulated amount of data is large or small, lengthens the blanking period if the amount of difference is large, and shortens the blanking period if the amount of difference is small.

9. The buffer control device according to claim 1, wherein the vertical synchronization signal generating section receives a signal notifying a blanking period from the vertical cycle control section and sets a point of change in the signal as a new vertical synchronization signal.

10. A receiving apparatus to which a broadcast program is transmitted as coded data in packets and which receives the data, the receiving apparatus comprising:
the buffer control device according to claim 1;
a system decoder configured to identify and output a packet having a predetermined identifier or a data pattern from inputted packets;
a video decoder configured to decode video data among data outputted from the system decoder;
a voice decoder configured to decode voice data among the data outputted from the system decoder; and
a host processor configured to make at least settings for each of the decoders and the buffer control device required for receiving the broadcast program, among the data outputted from the system decoder.

11. The receiving apparatus according to claim 10, wherein the settings are settings for filter conditions for extracting a TS packet having the predetermined identifier.

12. The receiving apparatus according to claim 10, wherein the settings are settings for a start pointer, an end pointer, a write pointer and a read pointer for a buffer.
